(19) United States
(12) Patent Application Publication
(10) Pub. No.: US 2016/0034712 A1
(43) Pub. Date: Feb. 4, 2016

(54) SYSTEM AND METHOD FOR EVENT-RELATED CONTENT DISCOVERY, CURATION, AND PRESENTATION

(71) Applicant: Banjo, Inc., Redwood City, CA (US)

(72) Inventors: Damien Michael Patton, Redwood City, CA (US); Rish Mehta, Redwood City, CA (US)

(21) Appl. No.: 14/882,318

(22) Filed: Oct. 13, 2015

Related U.S. Application Data
(63) Continuation-in-part of application No. 14/643,958, filed on Mar. 10, 2015.
Application No. 14/643,958 is a continuation-in-part of application No. 14/574,966, filed on Dec. 18, 2014, now Pat. No. 9,043,329.
Application No. 14/643,958 is a continuation-in-part of application No. 14/501,436, filed on Sep. 30, 2014, now abandoned.
Application No. 14/501,436 is a continuation-in-part of application No. 14/043,479, filed on Oct. 1, 2013, now abandoned.
(60) Provisional application No. 62/063,078, filed on Oct. 13, 2014.
(60) Provisional application No. 61/918,126, filed on Dec. 19, 2013.
(60) Provisional application No. 62/060,407, filed on Oct. 6, 2014.
(60) Provisional application No. 62/006,632, filed on Jun. 2, 2014.
(60) Provisional application No. 61/709,103, filed on Oct. 2, 2012.
(60) Provisional application No. 61/782,687, filed on Mar. 14, 2013.
(60) Provisional application No. 61/784,809, filed on Mar. 14, 2013.
(60) Provisional application No. 61/885,322, filed on Oct. 1, 2013.

(51) Int. Cl. G06F 21/62; H04L 29/08; G06F 17/30; H04L 12/58

(52) U.S. Cl. CPC G06F 21/6245; H04L 51/32; H04L 51/16; H04L 67/18; G06F 17/30887; G06F 17/30598

(57) ABSTRACT

A method for event detection and content surfacing, including: receiving a plurality of posts from a plurality of social networking systems; indexing each post; detecting an event within a geofence based on the post parameter values; identifying an event of interest based on the event parameter values; notifying a user account of the detected event when the detected event is determined to be of interest to the user account; aggregating event posts into a content stream for the user account; and facilitating user account interaction with and use of the event posts.

### CROSS-REFERENCE TO RELATED APPLICATIONS

This application claims the benefit of U.S. Provisional Application No. 62/063,078 filed 13 Oct. 2014, which is incorporated in its entirety by this reference.

This application is a continuation-in-part of U.S. application Ser. No. 14/643,958 filed 10 Mar. 2015. Application Ser. No. 14/643,958 is a continuation-in-part of U.S. application Ser. No. 14/574,966, filed 18 Dec. 2014, which claims the benefit of U.S. Provisional Application No. 61/918,126, filed 19 Dec. 2013, U.S. Provisional Application No. 62/060,407, filed 6 Oct. 2014, and U.S. Provisional Application No. 62/006,632, filed 2 Jun. 2014. Application Ser. No. 14/643,958 is also a continuation-in-part of application Ser. No. 14/501,436 filed 30 Sep. 2014, which is a continuation-in-part of application Ser. No. 14/043,479, filed 1 Oct. 2013, which claims the benefit of U.S. Provisional Application No. 61/709,103, filed 2 Oct. 2012, U.S. Provisional Application No. 61/782,687, filed 14 Mar. 2013, and U.S. Provisional Application No. 61/784,809, filed 14 Mar. 2013. Application Ser. No. 14/501,436 also claims the benefit of U.S. Provisional Application No. 61/885,322, filed 1 Oct. 2013, U.S. Provisional Application No. 61/918,126, filed 19 Dec. 2013, and U.S. Provisional Application No. 62/006,632, filed 2 Jun. 2014. All of the aforementioned applications are incorporated herein in their entireties by this reference.

### TECHNICAL FIELD

This invention relates generally to the social media field, and more specifically to a new and useful system and method of dynamic event-related content detection, curation, and presentation in the social media field.

### BACKGROUND

Social networking services can provide a rich source of data for real-time event detection, particularly with the increased popularity of users posting content from any geographic location, in real time, through their mobile devices. The inventors have discovered that this data can be particularly useful in applications requiring or are augmented by rapid event detection and categorization. Examples of such applications include breaking news stories, identifying witnesses for event-related interviews, identifying customer service complaints (e.g., during an event), and identifying financial market-impacting events (and projecting the impact of the event on the financial markets).

However, there are several problems posed by using social networking service content in the aforementioned applications. First, the sheer volume and frequency of content generated across each social networking service is immense-attempting to analyze all the content generated across multiple social networking services in real time poses considerable processing and modeling challenges. Second, the social networking service content is typically a mix of content with different focuses, ranging from content that is relevant to an event (e.g., an image of the event focus) to content that is irrelevant to an event (e.g., content that is only relevant to the user or the personal connections of the user), and are distributed across time and space. The volume of secondary content (e.g., content that is not about the event) tends to eclipse the primary content (e.g., content that is about the event), rendering detection of the beginning of an event difficult. Third, curation of the events poses an issue as well. In particular, there are multiple different types (categories or classifications) of events, which can range from minor, customer service events (e.g., a customer complaint), to major, breaking news events (e.g., a shooting or flood), wherein different events would be relevant or of interest to different users. For example, customer complaints would be interesting to an event overseer, but would be irrelevant to a news entity. Fourth, curation of the content relevant to the event poses an issue as well, as the event-associated content can range from content about the event focus to content about spectators of the event. For example, content about the event focus can be relevant to users interested about the event, while content about the event spectators tends to be irrelevant to the users and dilutes the value of an event feed that is generated from the event-associated content. Conversely, some entities can be interested in only the content generated by spectators of the event (e.g., a sporting event or music event), while content about the event itself is irrelevant to the entity and dilutes the value of the content feed generated from the event- or geographic region-associated content. The substantially real-time event detection can subsequently be used to notify users, used as a trigger event for trading models or trading triggers in financial market applications, or used in any other suitable manner. Fifth, even when event-related, user-relevant content is discovered, each entity's policy on how, when, and what procedures are required to use social networking system content varies drastically from its peers, making standardized author-facing policies (e.g., copyright policies, privacy policies, etc.) difficult.

Thus, there is a need in the social networking services field to create a new and useful system and method for automatic, real-time event detection based on content generated on social networking systems.

### BRIEF DESCRIPTION OF THE FIGURES

FIG. 1 is schematic representation of the method for event-related content surfacing.

FIG. 2 is a schematic representation of a variation of the system.

FIG. 3 is a schematic representation of a variation of post indexing.

FIG. 4 is a schematic representation of a variation of event detection and characterization.

FIG. 5 is a schematic representation of a variation of event classification.

FIG. 6 is a schematic representation of a variation of checking the privacy status for a post.

FIG. 7 is a schematic representation of a variation of identifying an event nexus and identifying authors satisfying a set of parameters proximal the event nexus (e.g., identifying witnesses).

FIG. 8 is a schematic representation of an example of a user interface with event notifications for a user account.

FIG. 9 is a schematic representation of an example of a user interface that enables user accounts to browse a timeline of event posts.

FIG. 10 is a schematic representation of an example of content stream generation for a geofence and an example of a user interface for location-based post browsing.

FIG. 11 is a schematic representation of an example of content stream generation for a monitored geofence and an example of a user interface for location-based post monitoring.

FIG. 12 is a schematic representation of a specific example of method use by a news entity to discover and use news content.

FIG. 13 is a schematic representation of a specific example of method use by a branding entity to discover and use potential advertising content.

FIG. 14 is a schematic representation of a specific example of method use by an event entity to discover and act upon customer complaints.

FIG. 15 is a schematic representation of a specific example of the method.

### DESCRIPTION OF THE PREFERRED EMBODIMENTS

The following description of the preferred embodiments of the invention is not intended to limit the invention to these preferred embodiments, but rather to enable any person skilled in the art to make and use this invention.

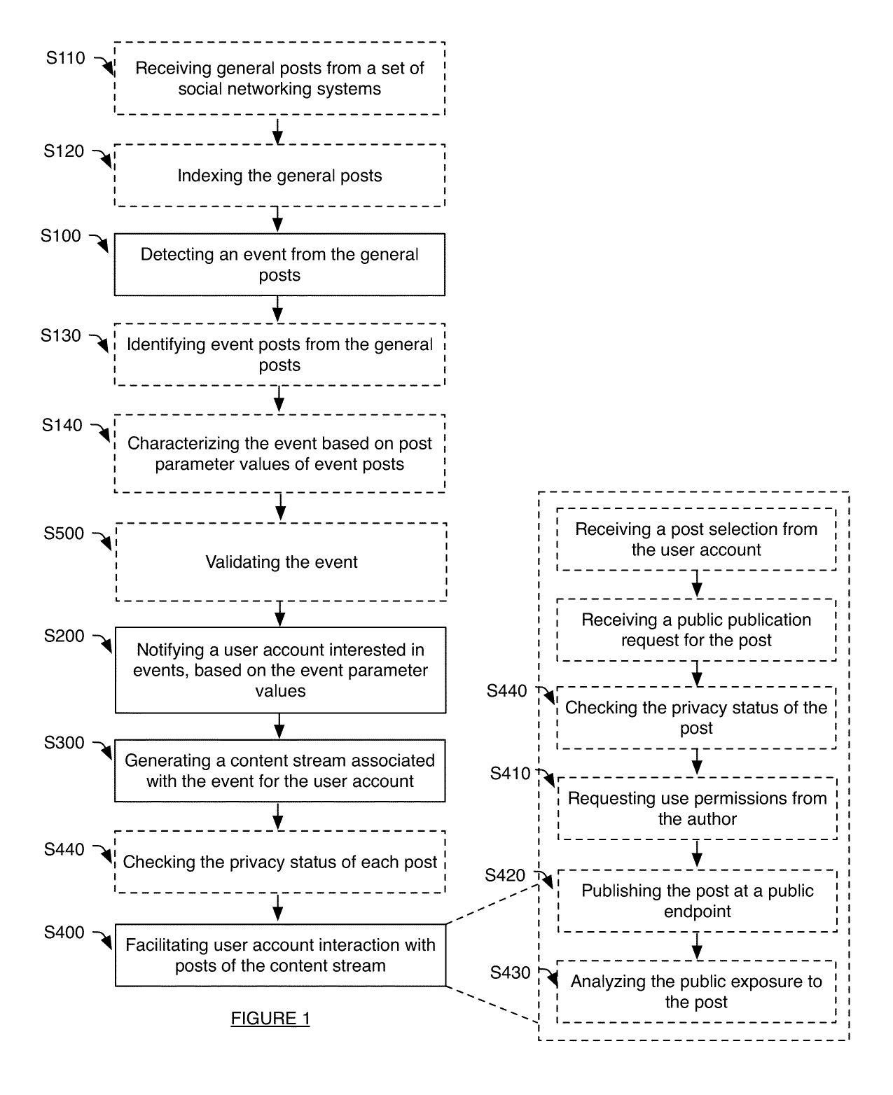

As shown in FIG. 1, the method for event-related content surfacing includes: detecting an event S100, notifying a user account of the event S200, generating a content stream associated with the event for the user account S300, and facilitating user account interaction with posts of the content stream S400. The method can additionally include: validating the event, publishing a post from the content stream (e.g., on a public endpoint), checking the privacy status of each post, obtaining use permissions (e.g., copyright permissions) from the post author, analyzing public exposure to the post, or include any other suitable module capable of manipulating, filtering, or otherwise working with the content data. The method is preferably performed by a platform, wherein the modules modify the basic functionality of the platform, but can alternatively be performed by any other suitable construct.

With the increased popularity and ease of creating image-based content (e.g., videos and images), the inventors have discovered that social networking services can be a rich source of data for discovering content for use in these applications. Examples of image-based content use can include: creating a news story; creating advertising content (e.g., grassroots-based advertising content, such as created by other consumers of the same brand, product, or service); identifying market-influencing events and taking financial action upon identification (e.g., hedging, selling, buying commodities, stocks, or other financial instruments); identifying the location of objects and/or people; or otherwise using image-based content.

The method confers several benefits over conventional systems. First, the method functions to filter through the immense amount of social networking data that is being generated within a geographic area, to identify content that is relevant to an entity. Even if the content is filtered using a geofence and/or keywords, a large amount of irrelevant content will still be identified, particularly when multiple social networking systems are monitored to identify the relevant content. For example, content being generated at a stadium hosting a sporting event can be content about the sporting event (e.g., images or videos of the plays), or can be irrelevant content (e.g., images of attendees, images of food, etc.). Because the entities are interested in only a small subset of the data and lack the resources (e.g., manpower) to filter through each piece of content, this method can provide an advantage to those entities by identifying the relevant content. Second, by providing the tools to interact with the content in the manner desired by the entity, the method simplifies identified content analysis. Third, this method enables branding customization to promote brand awareness and showcase content. Fourth, the ability to create advertising campaigns by curating content enables a user to target specific publication characteristics, such as overall content size, volume, type, or any other suitable metric.

The method is preferably performed in whole or in part by a system 100 including a set of servers, but can alternatively be performed by a native application on a user device, by a browser application on a user device, or by any other suitable apparatus. The set of servers can include one or more servers, wherein the servers can be stateless, stateful, or have any other suitable configuration or property.

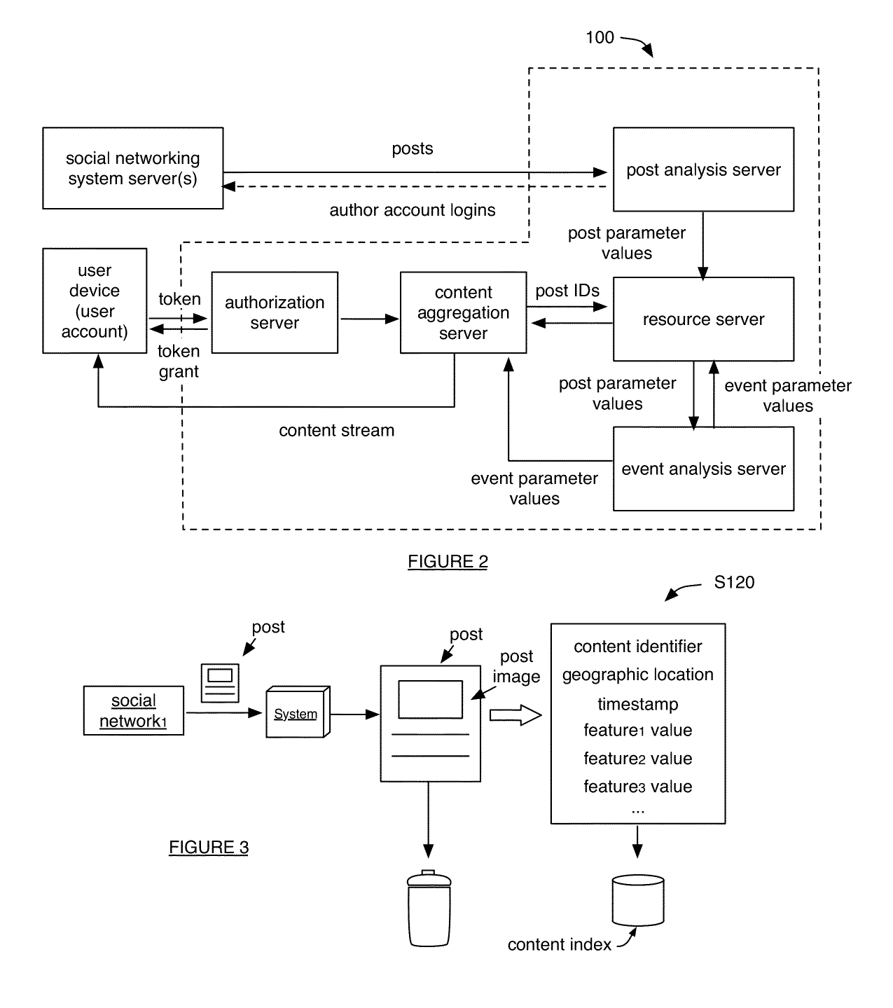

In one variation, as shown in FIG. 2, the system can include a resource server and an authorization server. The resource server preferably stores the post information, and can additionally index the post information for subsequent retrieval. The authorization server preferably stores the permissions for each user account (e.g., rewind time limits, geofencing limits, content stream volume limits, post use request limits, etc.), and can additionally store event parameter requirements for the user account (e.g., event filter; describing the events that the user is interested in), post requirements for the user account (e.g., post filter; describing the posts that the user is interested in), user account preferences, or store any other suitable user account data. The authorization server is preferably consulted before any social networking system content is provided to the user account, but can alternatively be used in any other suitable manner. The system can additionally include a content analysis server (post analysis server) configured to: determine a geographic identifier for the post (e.g., assign the geographic identifier, if lacking; confirm that tagged geographic identifier is related to the post content; etc.), determine a timestamp for the post (e.g., determine the time at which the post was generated, verify that the post timestamp was the post generation time, etc.), reduce the post to a set of feature values, and/or determine any other suitable information for each post. The content analysis server preferably provides post information to the resource server for indexing and storage. The system can additionally include an event analysis server configured to: detect an event occurring within a geofence based on content generated within the geofence (e.g., determine a probability that an event is occurring or has occurred within the geofence), determine event parameter values indicative of the event (e.g., based on the event-related posts), categorizing the event content (e.g., determine whether the event is related to a fire, riot, wedding, baseball game, etc.), determining whether the event falls within an event class of interest (e.g., whether the event qualifies as a news event, financial-sector moving event), and/or otherwise analyzing the detected event. The event analysis server can also provide event information to the resource server, which can subsequently store the event in association with event-related posts. The system can additionally include a content aggregation server that functions to aggregate the event-related content for the user account. However, the system can include any suitable set of servers.

The method is preferably used by a user account, but can alternatively be used by any other suitable entity. The user account can be representative of a news entity, branding entity, financial entity, or any other suitable entity. In a first example, the method can be used by the news entity to identify breaking news, discover content for news stories, discover witnesses to interview, or be used in any other suitable manner. In a second example, the method can be used by the branding entity (e.g., sporting brand, product brand, service brand, etc.) to discover complaints at a brand-sponsored event, discover what people like at an event (e.g., determine real-time recommendation and feedback on the event), discover social networking system content related to the event (e.g., generated by a participant of the event) for advertising, determine reach and/or conversion to determine a return on investment for advertisements using the social networking content, or be used in any other suitable manner. In a third example, the method can be used by financial entities to discover trends, market-affecting events, or in any other suitable manner.

The user device is preferably a computing device associated with the user or user account, including large-scale presentation systems (e.g., digital billboards, whiteboards, media screens, etc), mobile phones, laptops, smartphones, tablets, or any other suitable mobile device. The user device is preferably connected to the server, wherein the connection is preferably a wireless connection, such as WiFi, a cellular network service, or any other suitable wireless connection, a near field connection, such as radiofrequency, Bluetooth, or any other suitable near field communication connection, or a wired connection, such as a LAN line. The user device can additionally or alternatively function as the server, such as in a distributed network system. The mobile device (e.g., the device from which the post is received) can also be any of the computing devices mentioned above, and is preferably associated with an author or authoring account. However, posts can be received from any other suitable device.

The method is preferably utilized with a set of social networking systems (e.g., one or more social networking systems). In particular, the method can request and/or receive content from the social networking systems. The social networking service is preferably an online service, platform, or site that preferably includes a plurality of user accounts (authoring account), wherein each authoring account is preferably associated with a unique author (social networking system user). Examples of social networking systems include Facebook, Twitter, Linkedin, a digital group formed from linked email addresses, or any other suitable digital networking system. The social networking system preferably stores the generated content, but can alternatively facilitate persistent or temporary content storage on an external storage system. A given user can have a different user account for each of the set of social networking systems, wherein different information posted to different social networking systems by the same author through different accounts can be used to determine: the geographic location of the user, the geographic identifier that should be associated with the post, or any other suitable information. In one variation, cross-social networking system analysis can be performed in the manner disclosed in U.S. Pat. No. 8,341,223, filed 7 Jun. 2012, incorporated herein in its entirety by this reference. However, cross-social networking system analysis can be performed in any other suitable manner. The system is preferably capable of accessing and aggregating content from one or more user accounts of the user (e.g., authored content) and/or content authored by one or more connections of the user accounts. The content can be private content for which permissions have been given to one or more of the user accounts, or public content for which no permissions are required. The posts can be generated and/or posted by a user account of the social networking system user (e.g., authoring account), or by a user account of a connection of the user account on the social networking system (e.g., user accounts that are followed, friended, or otherwise directly connected to the user account). In one example, the content can be from a content feed associated with the user account, wherein the content feed can be a time-ordered list (e.g., ordered according to the time of generation), more preferably inversely time-ordered with the most recent content at the top of the list, but can alternatively be ordered according to popularity (e.g., as determined from the number of views of the content, number of actions on the content, etc.), or ordered according to any other suitable parameter. The method can additionally be used with a set of secondary information (e.g., weather information, security camera information, traffic information, etc.), or integrate any other suitable data from any other suitable source.

The posts received by the system are preferably general posts (e.g., all posts from the social networking system that the system has access to), wherein the general posts include geofence posts (e.g., posts that are associated with geographic identifiers within the geofence) and non-geofence posts (e.g., posts outside the given geofence). The general posts (e.g., global post) can additionally include event posts (e.g., posts related to the event). The event posts are preferably posts within the geofence in which the event is occurring, but can alternatively be posts associated with geographic identifiers outside of the geofence. The event posts are preferably associated with timestamps within the event time (e.g., associated with the event detection time), but can alternatively be associated with any other suitable timestamp. The event posts are preferably associated with the detected event (e.g., based on the respective post parameter values), but can alternatively be unassociated or otherwise related to the event. The event posts can include branding posts (e.g., posts having parameter values that a branding entity is interested in, such as posts with all or a portion of a brand's logo in the image, wherein the brand logo can be received from the branding entity or otherwise determined), witness posts (e.g., original posts that were originally authored by a witness to the event), or any other suitable event-related post. The posts that are considered during the method are preferably posts that are temporally proximal to an event detection time (e.g., when an event is detected), wherein temporally proximal posts are associated with timestamps within a predetermined time duration of the event time, but can alternatively have any other suitable associated timestamp. The event posts can be identified using machine learning modules (e.g., trained or untrained), deep learning modules, neural networks, probabilistic clustering, object matching algorithms, or using any other suitable analysis method.

Each post is preferably digital content that was posted (e.g., uploaded) to a social networking system (i.e., electronic messages, posts, content, persistent content, persistent data, persistent posts, etc.) by an author (e.g., through an authoring account), and can include URLs, links, references, text, images, video clips (e.g., a series of image frames and associated audio; a series of image frames, time-ordered or otherwise ordered; etc.), audio clips, and/or any other suitable content. The post can additionally include associated metadata (i.e., an associated set of data properties). The metadata can include a generation timestamp (e.g., the time of post generation, the time at which a picture was taken, etc.), a post timestamp (e.g., the time at which the post was posted to the social networking system), a geographic identifier (e.g., geotag, GPS coordinates, name of geographic location, name of a venue, etc.), a measure of location precision (e.g., radius of uncertainty), a categorization or identifier for the mobile device generating the content, the user account identifier, the content capture mechanism (e.g., front camera or back camera), or any other suitable parameter.

A location can be a set of geographic coordinates (e.g., latitude and longitude), a place name (e.g., county, city, landmark, intersection, etc.), a physical street address, distance from a given location, presence within a specified radius from a given location, a graphical depiction on a map, an identifier associated with the geofence in which the location is located, or any other suitable location expression. Geolocation can involve geocoding to find associated latitude and longitude from other geographic data. Geolocation can additionally or alternatively involve reverse geocoding to back code latitude and longitude coordinates to a readable address or place name. The location can be determined based on the method disclosed in U.S. application Ser. No. 14/043,479, GPS coordinates provided by a device, triangulation between mobile phone towers and public masts (e.g., assistive GPS), Wi-Fi connection location, WHOIS performed on IP address or MAC address, GSM/CDMA cell IDs, location information self-reported by a user, or determined in any other suitable manner. For example, a geographic location can be determined for and associated with the piece of content in the manner disclosed in Ser. No. 14/043,479 filed 1 Oct. 2013, incorporated in its entirety by this reference. However, any other suitable information can be determined and/or associated with the content in any other suitable manner.

The metadata is preferably representative of the respective parameters at the time of digital content creation or at the time the digital content was sent to the social networking system. The metadata is preferably associated with the digital content at the time of digital content generation (e.g., when the digital content is sent to the social networking system), but can alternatively be associated with the digital content upon social networking system receipt of the content (e.g., by the social networking system), associated with the digital content upon content receipt from the social networking system, or be associated with the digital content at any other suitable time. While the digital content preferably includes information for all available parameters, the digital content can alternatively lack information for some parameters, such as location information. The digital content can lack the parameter information due to a user preference restriction, due to the settings of the social networking system (e.g., wherein the social networking system does not associate location information with digital content), or for any other suitable reason. Alternatively, the digital content can be associated with a time, location, or any other suitable parameter in any other suitable manner. For example, a post can be associated with metadata, such as a time, location, and/or event name in the manner described in U.S. application Ser. No. 14/043,479 filed 1 Oct. 2013, incorporated herein in its entirety by this reference.

In one variation, the method can be used with a set of geofences, wherein a geofence can be predetermined or specified by a user account (e.g., monitored by a user account). A geofence can be a virtual representation of a geographic region, wherein the geographic region can encompass one or more geographic locations. Alternatively, the method can be performed with a set of spacefences, which can define a three-dimensionally limited space to be monitored. Each geofence preferably includes an imaginary boundary enclosing a geographic region, wherein the boundary includes a set of imaginary segments forming a closed loop encircling the geographic region. However, the boundary can alternatively include a circle or other shape defined relative to a geographic location (e.g., a center point), or be defined in any other suitable manner. The segments are preferably linear segments, but can alternatively be curved or otherwise defined. The boundary can form a geometric shape (e.g., a polygonal shape) and is preferably non-circular, but can alternatively define a circle or any other suitable shape.

The geographic region enclosed by the geofence preferably encompasses one or more geographic locations, but can alternatively cover any other suitable geographic area. Examples of geographic regions include solar systems, a surface of an entire planet, a planet volume, continents, countries, states, counties, cities, communities, buildings, and rooms. The geographic region preferably encompasses one or more geographic locations (e.g., geographic locations, event locations, physical locations, etc.), wherein a geographic location can be identified by a venue name, a user-defined name (e.g., “home”), a set of GPS coordinates, a set of latitude and longitude coordinates, a set of wireless cell tower triangulation information, an address, or any other suitable identifier for a geographic location.

The shape and size of the geofences are preferably predetermined, but can be dynamically determined. The geofences can be predetermined, automatically determined (e.g., based on feature values, content parameters, etc.), determined by a user, determined by a plurality of users (e.g., wherein the boundary is set or stored within the system after a threshold number of users select the boundary, within a predetermined accuracy threshold), randomly determined, determined based on physical barriers (e.g., run along a wall, etc.), determined based on political delineations (e.g., along a city border, country border, etc.), determined based on third party reference points (e.g., cell tower coverage areas, etc.), be predetermined geographic increments (e.g., 150 m by 150 m squares), or determined in any other suitable manner. The geofences can be entered by an administrator (e.g., a user with administrator permissions), determined when a threshold number of users have entered the same geofence (within a given degree of variability) within a threshold period of time, determined based on historical content generation densities over space (e.g., wherein the geofence is defined by the locations at which the content density falls below a threshold value), or defined in any other suitable manner.

Each geofence preferably includes a single boundary, such that a geofence encloses a continuous geographic region within the respective boundary. However, the geofence can include multiple boundaries, wherein the boundaries are preferably nested (e.g., such that the geofence encloses an annular region or a region is excluded from the geofenced region). Boundaries independently enclosing separate or overlapping geographic regions are preferably considered separate geofences, but can alternatively be considered part of the same geofence.

The method is preferably used to monitor content posted to a social networking system from a geographic region. The geographic region (e.g., physical region) is preferably defined by digital boundary enclosing a geographic focus. The geographic focus can be a venue, political region (e.g., neighborhood, city, county, state, country), landmark, or any other suitable geographic area. The boundary of the geographic region can define venue borders, political boundaries, landmark boundaries, or boundaries of any other suitable geographic location. The boundary preferably encloses geographic locations from which a user might generate information about an event associated with the geographic focus. For example, the boundary for an enclosed stadium might enclose the region bounded by the walls of the stadium in addition to the parking lot adjacent the stadium or parking lot for the stadium. The boundary might extend along the walls of the stadium and the parking lot property line, or might extend external the stadium walls and/or property line. In another example, the boundary for an open air concert hall can enclose the region physically bounded by the walls of the hall in addition to a viewing region outside the official property line of the concert hall (e.g., enclose a hill proximal the hall from which the stage can be seen). In another example, the boundary for a dynamically detected event (e.g., a breaking news event, such as a fire), can enclose the geographic region affected by the fire (e.g., the geographic region that is on fire, the geographic region including the fire and the smoke cover, the region evacuated due to the fire, etc.). The geographic region affected by the fire can be determined from the geographic locations of the event posts, the content of the event posts, triangulation of the event posts, or determined in any other suitable manner. The boundary can be static or dynamically change as the event progresses. Alternatively, the digital boundary can encapsulate a geographic region without a specific geographic focus, wherein the set of digital boundaries preferably cooperatively encapsulates the entirety of a geographic location, such as the surface of a planet, but can alternatively encapsulate a subset of the geographic location. The set of digital boundaries preferably define a set of contiguous (e.g., adjacent or abutting), non-overlapping geographic regions, but can alternatively define a set of overlapping regions or any other suitable set of geographic regions to monitor. The geographic region defined by each of the set of digital boundaries preferably covers the same or similar (e.g., within a margin of error) area, but can alternatively cover different areas. For example, the digital boundaries can be defined by a virtual grid overlaid on a map of the geographic location. The grid can be a two-dimensional grid, a three-dimensional grid (e.g., taking into account terrain), or any other suitable grid.

The method is preferably used to identify content generated at an event, more preferably at an event location, even if the content is not specifically geotagged with the event location. This method is preferably utilized with a primary event detection and/or classification method, such as that disclosed in Ser. No. 14/643,958 filed 10 Mar. 2015, but the event can be otherwise detected, categorized, or used.

An event is preferably an intersection of a physical region and a set of feature values. The event can additionally be associated with a timeframe. The event can be predetermined (e.g., a planned event, such as an awards ceremony), recurring, spontaneous (e.g., a car crash), public, private (e.g., “work,” “at home,” etc.), or any other suitable event. The event is preferably a spontaneous event that is dynamically determined, but can alternatively be a pre-defined or user-defined event. A pre-defined or user-defined event is preferably an event wherein a combination of event parameters defining the event is explicitly received from or defined by a user, and can be a calendar event, a recurring event, or any other event defined in any other suitable manner. A spontaneous event is preferably dynamically determined from the parameters of non-calendar content (e.g., non-calendar events), wherein the combination of event parameters defining the event (e.g., event location or region, timeframe, attendees, etc.) is not pre-determined or received from a user (user-defined). The spontaneous event is preferably determined based on a content parameter value, wherein the event can be determined when the content parameter value exceeds a threshold value. An event is preferably determined in response to the probability of the event exceeding a threshold probability, but can alternatively be determined in response to any other suitable event. More preferably, the method functions to calculate the probability that an event is currently occurring within a geofence, wherein the geofences and/or event regions and associated event labels can be ordered based on the respective probability.

The event can additionally be associated with an event timeframe, which functions to delineate the start and stop times of the event. In one variation, the event timeframe can be used to determine when an event has begun, or when the event starts becoming relevant to a population of users (e.g., and therefore promoted to users). The event timeframe can also be used to determine when an event has ended, or when the event has ceased being relevant to a population of users (e.g., and therefore not promoted to users). However, the event timeframe can be used in any other suitable manner. The event timeframes can be predetermined or dynamically determined, such as based on the event probability. In one variation, the event start time can be determined based on the time at which an event probability for the geofence rises above a threshold probability, and the event end time can be determined based on the time at which the event probability for the geofence falls below a second threshold probability. Alternatively, the event start time can be determined based on the time at which an event probability for the geofence increases beyond a threshold rate, and the event end time can be determined based on the time at which the event probability for the geofence decreases beyond a threshold rate. However, the event timeframe can be otherwise determined.

### 1. Detecting an Event

Detecting an event S100 functions to identify an occurrence of interest to the user account. The event can be detected by monitoring posts for each of a set of standard geofences, and detecting an event when abnormal posts (or a continuous set thereof) are received for the geofence. In some variations, the event is detected in the manner disclosed in U.S. application Ser. No. 14/643,958 filed 10 Mar. 2015, but can alternatively be detected in any other suitable manner. However, the event can be detected in any other suitable manner.

In one variation, detecting the event can include: receiving a plurality of posts from a plurality of social networking systems S110; for each post of the plurality, indexing the post (e.g., determining a geographic identifier, a timestamp, and a set of post parameter values for the post) S120; and for a geofence, detecting an event at a first time based on the post parameter values of geofence posts S130.

The plurality of posts are preferably each generated by a different author on the respective social networking system, but can alternatively be generated by the same author. The plurality of posts can be pulled from the social networking system(s) (e.g., at a predetermined frequency, in response to the occurrence of a pull event), but can alternatively be passively received from the social networking system(s) (e.g., automatically pushed by the social networking system to the system), or be otherwise received.

Each post is preferably indexed S120 in the manner disclosed in U.S. application Ser. No. 14/643,958 filed 10 Mar. 2015, but can alternatively be indexed in any other suitable manner (example shown in FIG. 3). In one variation, the post can be indexed by determining post parameter values for the post (e.g., feature values for the post), based on the post contents (e.g., reducing the post to post parameter values, extracting post parameter values from the post, etc.). The post parameter values (feature values) can be used to: categorize the post (e.g., as a complaint), detect objects of interest within the post (e.g., logos or portions thereof), detect the occurrence of an event within the geotag, categorize the event and/or image with an event categorization (e.g., event type), classify the event (e.g., as a news event when the news probability exceeds a threshold probability), or be used in any suitable manner. Different feature subsets are preferably used in each of the aforementioned uses, but the same feature subset can alternatively be used. In one example, the geographic identifier for a post can be determined based on portions of objects, having known geographic locations (e.g., determined from historic images or posts recorded at the respective geographic location or otherwise determined), that are identified within the post image (e.g., used as a “fingerprint”). In an illustrative example, a portion of a leg of the Eiffel tower can be used to determine that the image was taken by the Eiffel tower. This can additionally be used to determine whether the image was recently recorded (e.g., the author is currently collocated with the Eiffel tower, based on posts from one or more of the author's social networking accounts) or recorded in the past (e.g., the author is currently located far away from the Eiffel tower).

The post parameter values are preferably determined based on a set of feature values extracted from the post, but can alternatively be determined based on any other suitable set of information. The post parameter values can be determined based on the post content (e.g., photos, video, text, hashtags, etc.), author (e.g., based on historical posts by the author, the author's social graph, etc.), context (e.g., the time-ordered image stills of a video, taken together), temporally adjacent posts from the author, temporally adjacent posts from the geofence, the location history, secondary information (e.g., weather information, security camera information, etc.), or be determined based on any other suitable set of factors.

The post parameter values can include: the presence of an object (e.g., fire, logo, etc.), extent or relative size of the object (e.g., fire relative to image, fire relative to reference object of known size within image, etc.), the percentage of the object within the image (e.g., percentage of the logo within the image) keywords, hashtags, event category probability (e.g., news probability, etc.), or include any other suitable measure of a post parameter. The post parameter values can be determined using machine learning modules (e.g., trained or untrained), deep learning modules, neural networks, probabilistic clustering, object matching algorithms, or using any other suitable analysis method. In one example, the post parameter values can be determined by: analyzing image for key features and generating the post parameter values based on the key features present within the image. In a specific example, the key feature can be a predetermined object (e.g., a logo), wherein post parameter value can be the presence of a predetermined object and/or percentage of a predetermined object visible within an image of the post. In a second example, the post parameter value can include detecting a fire within a post image, and can additionally include a classification that the first is a controlled bonfire, and not an uncontrolled forest fire. However, the post parameter values can be otherwise determined. In an illustrative example, the post can include a video of a plane crash. The post parameter values that can be extracted from the post include “plane,” “plane crash,” and “fire,” in addition to the contextual conclusion that the fire was caused by the plane crash.

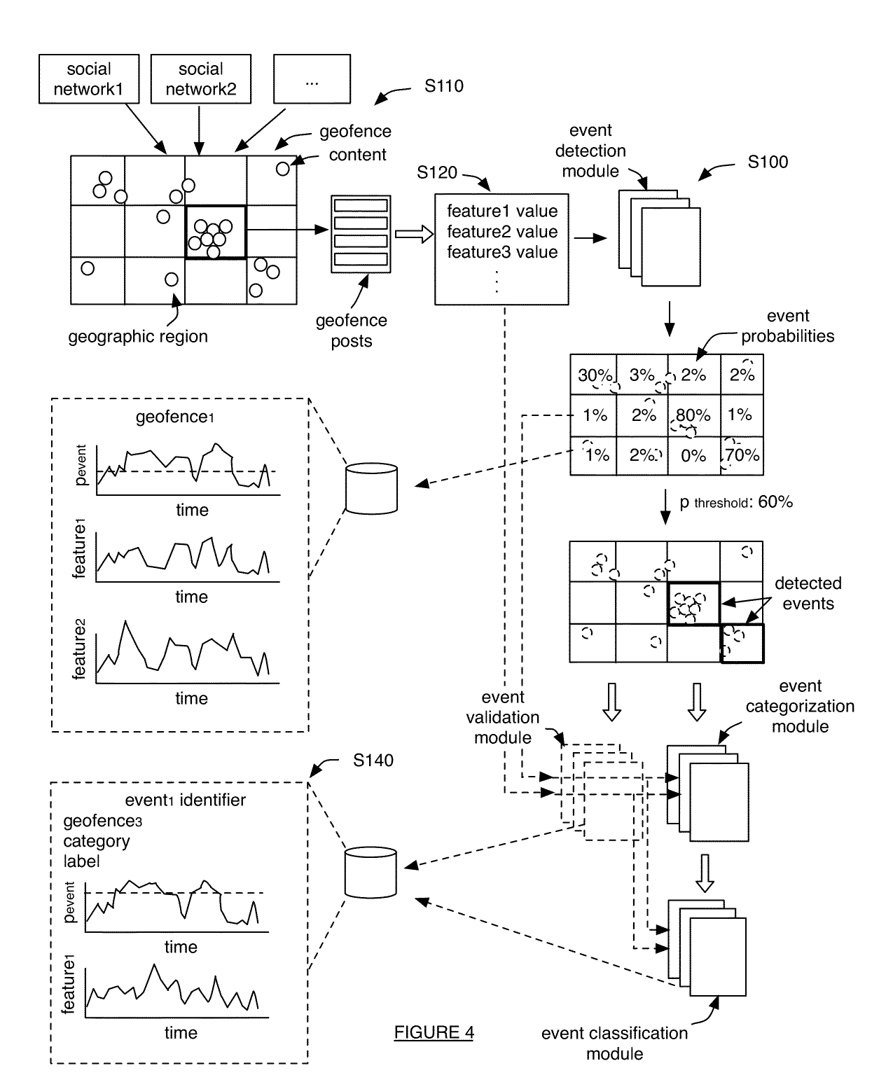

The event is preferably detected S100 based on the post parameter values of the geofence posts for a monitored geofence (example shown in FIG. 4). The event can be detected based on a single post, wherein subsequent geofence posts can reinforce the event signal. For example, an event can be detected from a single geofence post having post parameter values different from expected post parameter values for the time period within the geofence (e.g., based on historical post parameter values for the geofence during that time). Alternatively, the event can be detected after a critical mass of geofence posts have been received (e.g., wherein a threshold frequency of abnormal posts for the geographic region must be received), or be detected in any other suitable manner.

Detecting the event S100 can additionally include identifying event posts S130. The event posts can be identified as anomalous posts or content for the geofence during the time period, but can alternatively be identified as posts with post parameter values having above a threshold probability of being related to a previously detected event, posts with post parameter values substantially matching event parameter values, or be otherwise identified. The event posts are preferably identified as anomalous posts when the anomaly probability for the post exceeds an anomaly threshold (e.g., the same or different threshold for event validation, but can alternatively be otherwise identified. The anomaly probability for the post can be determined based on historic posts from the authors of the event posts; historic posts associated with the geofence; secondary information received from secondary sources; and/or any other suitable information. For example, the post can have a high anomaly probability if smoke is present in the post's image, smoke is not present in the nearest neighbor posts for the geographic location (e.g., typically not seen in the geographic location during that time of day), smoke is not present in past posts by the author, smoke is not present in the past posts by social connections to the author (e.g., through the author's social graph), and the post depicts blue sky in the background (indicative of daylight) and the current weather for the geographic location indicates that it is currently daytime with clear skies. The anomaly probability and/or anomalous posts for each geographic location can be determined using machine learning modules (e.g., trained or untrained), deep learning modules, neural networks, probabilistic clustering, object matching algorithms, or using any other suitable analysis method.

Detecting the event S100 can additionally include characterizing the event S140, which functions to abstract the post parameters for the geofence posts (e.g., posts within the event geofence) and/or event posts into event parameter values to characterize the event. The event parameter values can be generated based on the post parameter values of the geofence posts and/or event posts, generated based on secondary information, or be generated in any other suitable manner. The event parameter values can be determined in the manner disclosed in U.S. application Ser. No. 14/643,958, but can alternatively be otherwise determined. The event parameter values can be determined at a predetermined frequency, be determined each time a new geofence post is received, be determined each time a new event post is received, be determined each time a new event-related post is received (e.g., outside of the geofence or within the geofence), or be determined at any suitable time. The event parameter values are preferably automatically updated in near-real time as the geofence, event, event-related, and/or other posts are received (e.g., within minutes, seconds, milliseconds, or nanoseconds of receipt; within hardware-limited processing times after receipt; immediately after receipt; etc.), but can alternatively be updated at any other suitable frequency.

Detecting the event S100 can additionally include classifying the event. The event is preferably classified based on the event parameter values, but can alternatively or additionally be determined based on the post parameter values of the event posts, geofence posts (e.g., those within a threshold period of time from an analysis time), external information sources (e.g., an event schedule for the geographic location), or be classified based on other data. An event can qualify as one or more event classes. Examples of event classes can include: “news,” “sports,” “trending events,” and “music,” but can alternatively include any other suitable event class. The event can be classified in the manner disclosed in U.S. application Ser. No. 14/643,958, but can be otherwise classified. In one example, event classification can include: determining an event probability for the geofence based on a first subset of the features (e.g., a probability that an event is occurring within the geofence); and categorizing the event based on a second subset of the set of post parameter values (e.g., “fire,” “baseball”), wherein the second subset is different from the first subset and indicative of the event category (e.g., indicative of fire). Classifying the event can additionally include determining the probability that the detected event is news (e.g., the news probability) based on the event categorization, the event probability, and a third subset of the set of post parameter values different from the first and second subsets, wherein the third subset of post parameter values is indicative of breaking news events. The event can be classified using machine learning modules (e.g., trained or untrained), deep learning modules, neural networks, probabilistic clustering, object matching algorithms, or using any other suitable analysis method.

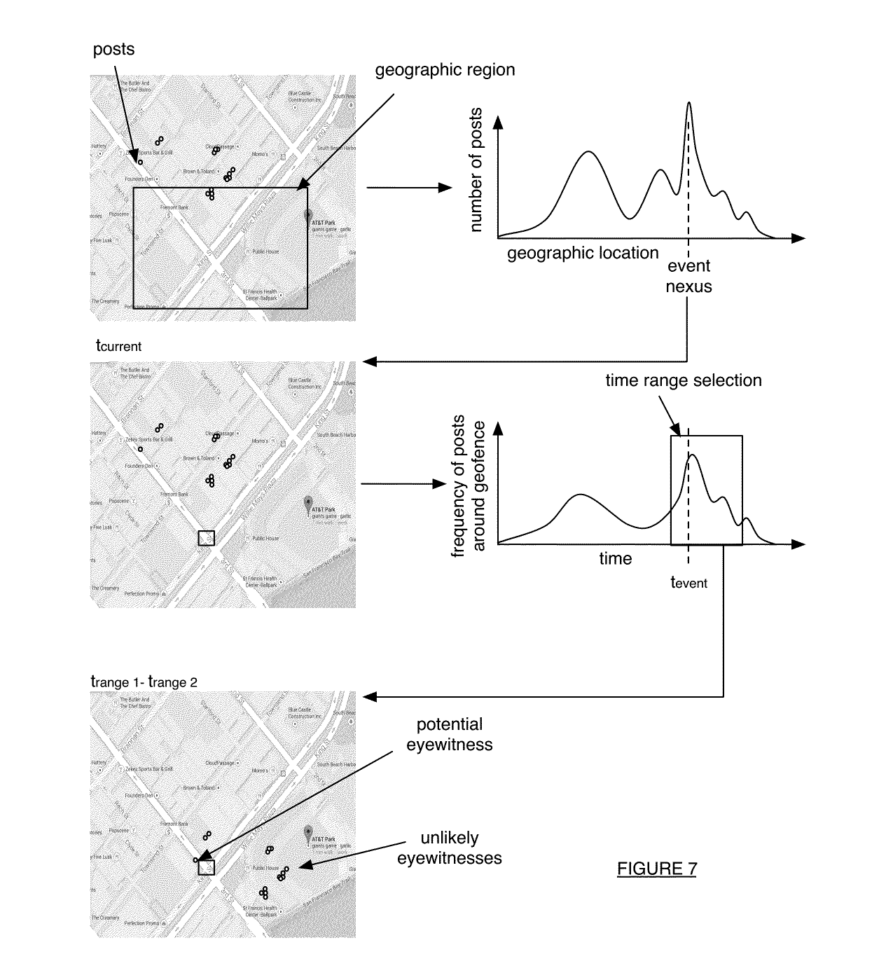

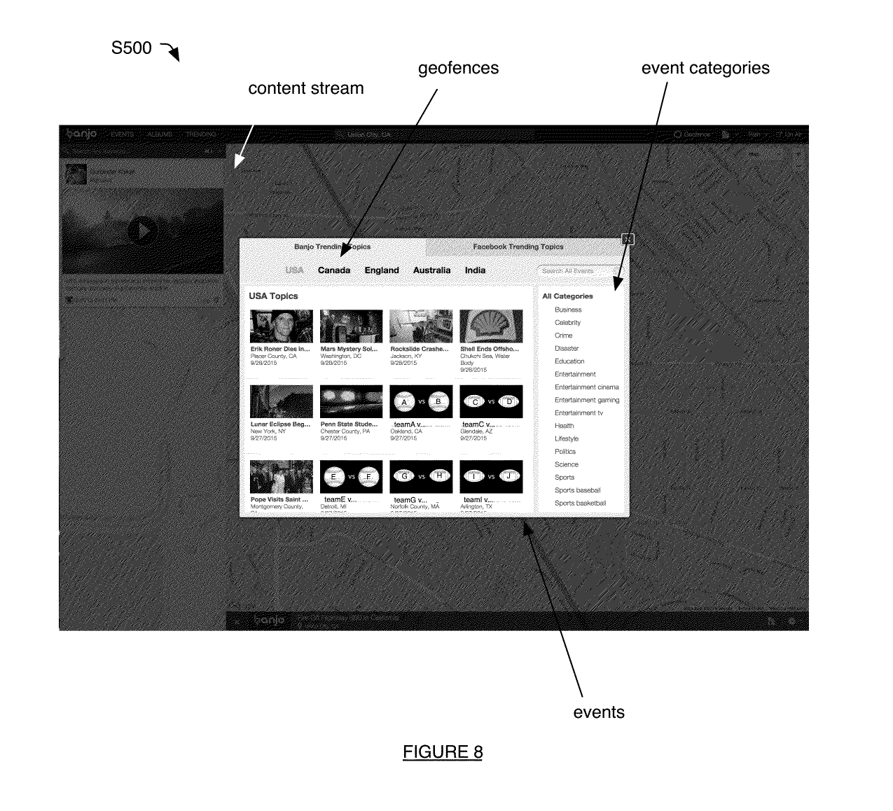

Detecting the event S100 can additionally include analyzing the event location based on the parameter values of one or more posts. Analyzing the event location can include: determining the extent of the event (e.g., based on the physical distribution of event-related posts within a predetermined timeframe after event detection), determining the event nexus (example shown in FIG. 7), identifying a landing site proximal the event location or lack thereof, or otherwise analyzing the geographic region surrounding the event location. The event region can be analyzed using machine learning modules (e.g., trained or untrained), deep learning modules, neural networks, probabilistic clustering, object matching algorithms, or using any other suitable analysis method.

In a first example, the detected event can be a mini-event within a larger monitored event, wherein the monitored event is monitored for a branding entity. In a specific example (as shown in FIG. 14), an event geofence (monitored geofence) can be monitored during an event time for a pre-planned event, wherein the detected events can be the occurrence of a complaint S310. The complaint can be determined from a complaint post, when the respective post parameter values substantially match a complaint profile, when the complaint probability calculated from the post parameter values is above a threshold probability (e.g., using a subset of parameter values determined to be indicative of a complaint), when the event parameter values for the complaint location (smaller than the monitored geofence) has a complaint probability higher than the threshold probability, or otherwise classifying the post as a complaint. The complaint post is preferably an event post (e.g., within the event geofence during the event period), but can alternatively be any other suitable post.

In response to complaint determination, the method can additionally include: determining a location associated with the complaint S312 (e.g., based on the complaint geographic identifier), such that targeted customer service can be provided in real- or near-real time to the complainant's location (e.g., localized offers provided at the location, representative sent to the location, etc.). The method can additionally include validating the complaint S314 (e.g., verifying that there is a real problem occurring in the complainant's location, that the complaint is not a singular or unique complaint, etc.). Validating the complaint S314 can include identifying secondary posts related to the complaint (secondary complaint posts). The secondary complaint posts can be event posts, general posts, geofence posts, or any other suitable type of post. The secondary complaint posts are preferably generated within a threshold time of the first complaint post, and/or can be associated with geographic locations within a threshold distance (e.g., number of monitored geofences, threshold radius, etc.) of the complaint post location. The secondary complaint posts are preferably substantially similar to the first complaint post (e.g., share common parameter values, such as keywords or topic classifications), but can be otherwise identified. In one variation, identifying the secondary complaint posts can include: identifying a subset of post parameters (e.g., factors) indicative of the complaint, based on the post parameter values of the first complaint post; identifying secondary complaint posts that are associated with geographic identifiers located proximal the first complaint location (e.g., within the sub-event region associated with the first complaint, within the event region, etc.) and associated with timestamps within a predetermined time period of the first complaint timestamp; determining the complaint similarity (e.g., as a probability, based on a nearest neighbor analysis, etc.) based on values of the subset of post parameters for the secondary complaint posts; and classifying the complaint as a valid complaint in response to the complaint similarity exceeding a threshold similarity (e.g., the similarity probability exceeding a threshold probability, the complaints sharing keywords, etc.). However, complaints can be otherwise identified. A complaint notification is preferably sent to the user account in response to complaint detection, but any other suitable action can be taken. The complaint notification can include the complaint, the complaint topic or classification, the complaint location, the complaint time, and/or any other suitable information about the set of complaint posts.

In a second example, a set of geofences can be continually monitored for a breaking news event, wherein detecting the news event can include: determining an event probability for the geofence based on a first subset of the features (e.g., a probability that an event is occurring within the geofence); and categorizing the event based on a second subset of the set of post parameter values (e.g., “fire,” “baseball”), wherein the second subset is different from the first subset and indicative of the event category (e.g., indicative of fire); determining the probability that the detected event is news (e.g., the news probability) based on the event categorization the event probability, and a third subset of the set of post parameter values different from the first and second subsets, wherein the third subset of post parameter values is indicative of breaking news events; and classifying the event as news when the news probability exceeds a threshold probability (example shown in FIG. 5). The monitored geofences can be set by the news entity (e.g., for local news), be global (e.g., wherein all geofences are monitored for breaking news), or be any other suitable geofence. However, the news event can be detected in any other suitable manner.

### 2. Notifying a User of the Event

Notifying a user account of the event S200 functions to filter the numerous events that are detected to identify events of interest to the user account. The user account is preferably notified of an event when the event parameters satisfy a set of event parameter requirements associated with the user account, but can alternatively be notified at any other suitable time. The set of event parameter requirements can be received from a user account, automatically determined for the user (e.g., based on past events of interest or selected by the user), or otherwise determined. Examples of event parameter requirements that can be selected include: a news event probability above a threshold probability value (e.g., which a news entity interested in breaking news can select); a monitored geofence (e.g., wherein the user account can be notified whenever a new event within the monitored geofence is detected); a monitoring timeframe having a start and end timestamp (e.g., wherein the user account can be notified whenever a new event during the monitored timeframe, or having an associated timestamp between the start and end timestamp, is detected); a category (e.g., wherein the user account can be notified whenever an event with a category probability exceeds a threshold category probability, or whenever an event falling within the category is detected); include a combination thereof; or include values for any other suitable post or event parameter. The event parameter requirements can also be used to filter out events (e.g., pre-planned events). For example, the baseball game can be filtered out of the events surfaced to a baseball entity related to one of the teams playing in the game, while mini-events occurring within the baseball game (e.g., fights, celebrations, caught flyballs, etc.) can be surfaced to the baseball entity.

An event notification is preferably automatically generated and sent or provided to the user account when an event meeting the set of event parameter requirements is met (example shown in FIG. 8). However, the event notification can be manually generated and/or sent, or be otherwise generated and presented to the user. In one example of manual event notification, the system can notify a verification entity (e.g., a user, automated computing module, etc.) of the event, wherein the event notification is sent to the user account upon event verification by the verification entity. The event notification can include a description of the event, a link to an event-related content stream, the content stream itself, a link to connect to the system, an event title, venue name, event synopsis, and/or include any other suitable information. The event notification can be automatically generated from the event posts, added by the verification entity, or be otherwise generated and associated with the event and/or event notification.

### 3. Content Stream Generation.

Generating a content stream associated with the event for the user account S300 functions to surface event-related content that would be of interest to the user account, and/or filter less relevant content. The content stream is preferably a collection of post identifiers, but can alternatively be a collection of posts, collection of post content (e.g., just the images and/or video), or include any other suitable content. The content stream can additionally include secondary information and/or secondary information identifiers (e.g., news articles, related events, analytics, results, etc.) related to the event. The content stream is preferably related to the event, and is composed of event posts, but can alternatively include general posts or any other suitable post. The content stream is preferably updated in real-time or near-real time with new global, geofence, event, or other posts as they are received, but can alternatively be updated with any other suitable information at any other suitable frequency. The content stream can be automatically generated and updated, but can alternatively be generated, adjusted (e.g., curated), and/or updated by a user (e.g., in response to receipt of a user input from a user account). The content stream can automatically be provided to the user account (e.g., as part of the event notification); be provided in response to receipt of a request for content associated with the event from the user account; or be provided to the user account at any other suitable time. The content stream can be ordered by relevance to the user (e.g., in decreasing order of event relevance or probability of the post being related to the event; in decreasing probability that the post meets the post requirements, etc.), by time (e.g., by increasing or decreasing time order), by proximity to an event nexus, or be ordered in any other suitable manner. The content stream is preferably provided to the user account after checking privacy settings for each post within the content stream, but can alternatively be provided to the user account before checking privacy settings or be provided at any other suitable time.

The posts included or identified within the content stream preferably must satisfy a post requirement to be included within the content stream, but can alternatively be included in the content stream for any other suitable reason. Examples of posts included in content streams include: event posts; posts with images; only posts with images; posts having a specific set of feature values (e.g., branding posts, such as posts that include a predetermined logo or portion thereof; customer service posts, such as posts that have a complaint probability above a threshold probability); posts without profanity in the image, video (e.g., in the video frames or audio), and/or associated text; or include any other suitable set of posts. In one variation, generating the content stream can include filtering the event posts for posts that meet the post requirement, then adding the posts meeting the post requirement to the content stream. In a second variation, generating the content stream can include adding all event posts to the content stream, then removing posts from the content stream (e.g., removing posts that do not satisfy the post requirement from the content stream, removing posts selected by the user account from the content stream, removing posts sharing common post parameter values with a post marked by the user account for removal, etc.). However, the content stream can be otherwise generated.

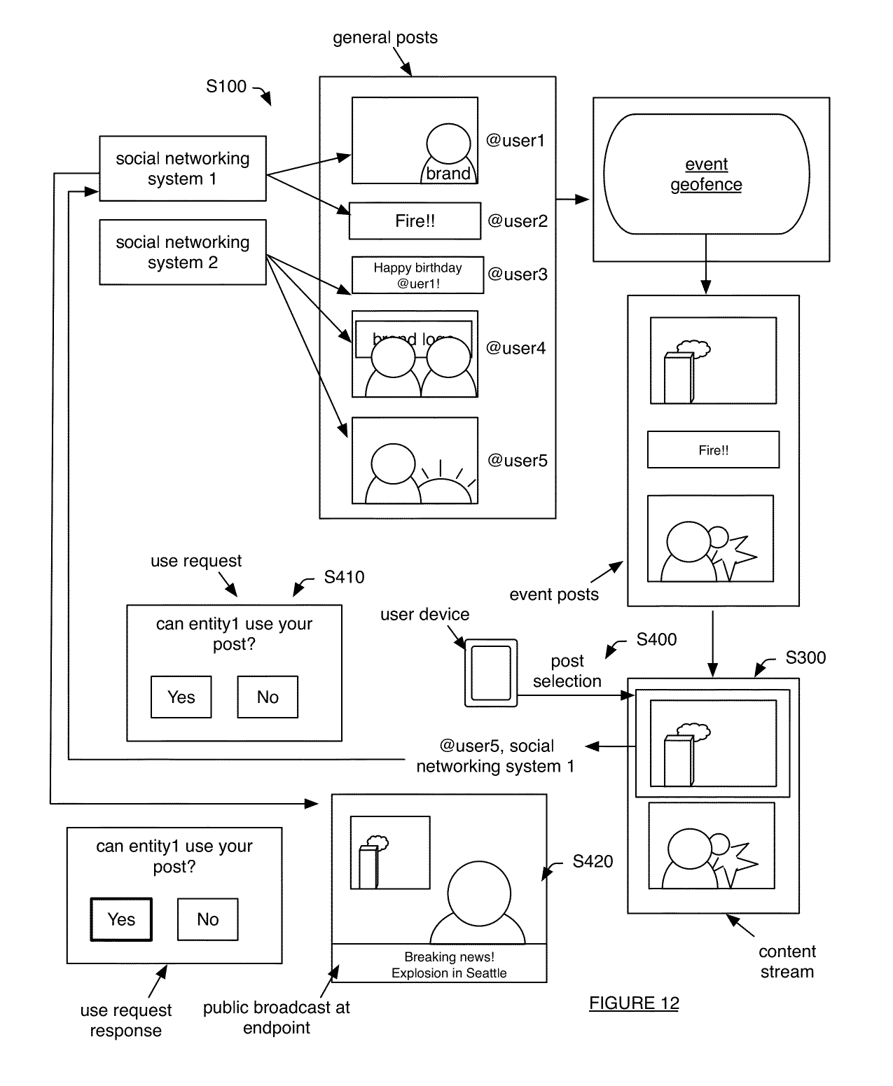

In a first specific example, only event posts including images (e.g., still images, video, graphics interchange format files, etc.) can be aggregated into the content stream for a news entity, and sent to the news entity in response to an event content request from the news entity. Alternatively, all event posts can be aggregated into the content stream for a news entity and sent. Alternatively, all event posts authored by witnesses to the event (e.g., authors that posted content, event-related and/or any content, from the event location within a threshold time period after the event time or event detection time) can be included in the content stream. However, any other suitable content can be included in the content stream for a news entity. The news entity can then select posts, secondary information, or portions thereof, from the content stream for use in live broadcast (example shown in FIG. 12), research and/or material for subsequent stories, or for any other suitable use. The selected posts or portions thereof can be published through a widget of the system, a widget of the entity, a widget or tool (e.g., an API) of the endpoint, or published through any other suitable channel.

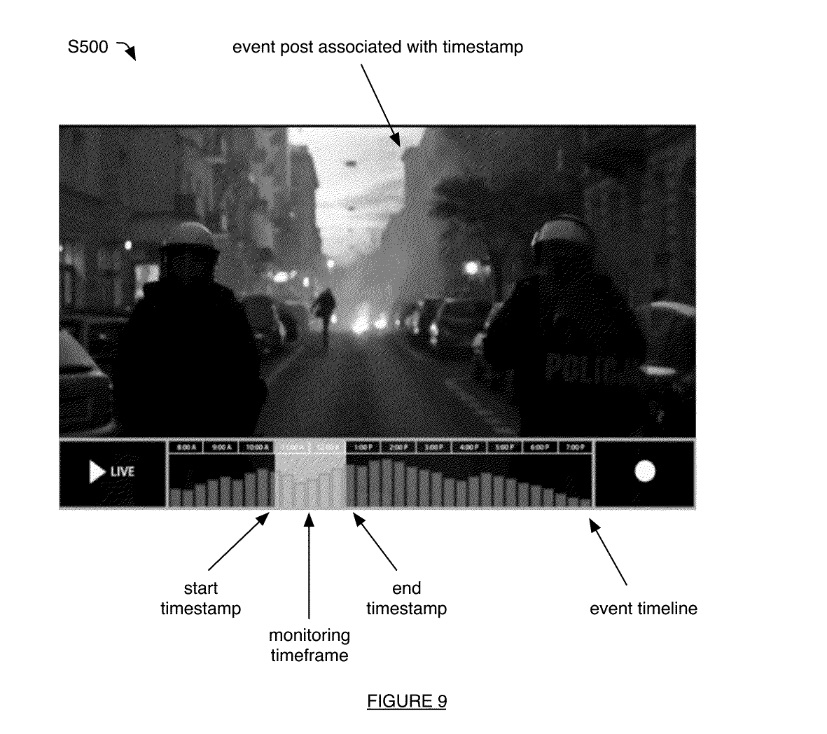

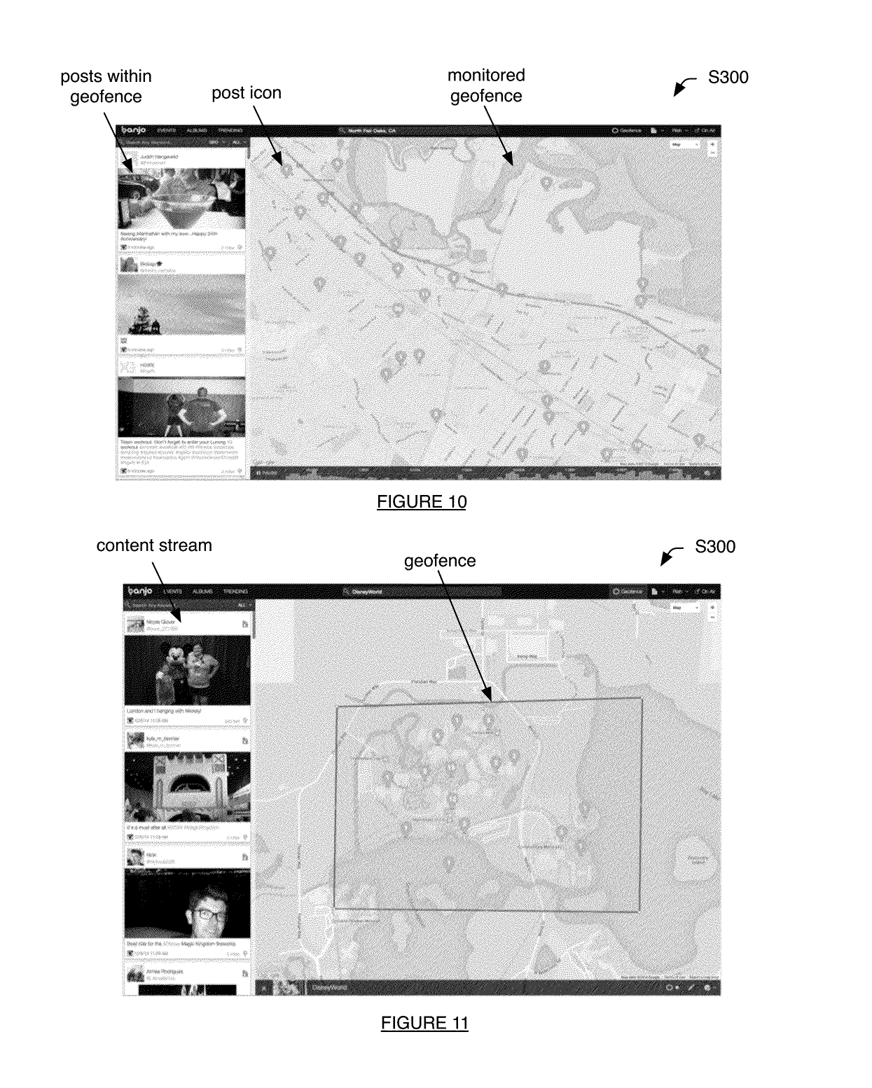

In a second specific example, the content stream can include event posts within a predetermined location during a predetermined time period, wherein the user can select a timestamp within the predetermined time period and view posts generated during or near that timestamp, example shown in FIG. 9. This can function to enable a user to “rewind” the event, and/or view a time-ordered content stream. In this specific example, the method can include: determining an event identifier from the post parameter values for the event posts; associating the event identifier with the event posts; receiving a timeframe request from the news entity for the event identifier, the timeframe request comprising a start and end time; identifying event posts that are associated with the event identifier and a timestamp falling between the start and end time; and sending identifiers for the event posts to the news entity as part of the content stream. Privacy settings for each identified event post can be sent prior to sending the identifiers, wherein only posts with public settings are sent, but the privacy settings for each post can remain unverified. The method can additionally include checking user account permissions for the requested timeframe. For example, a user account can be limited to only viewing posts generated up to 24 hours ago, such that the user account cannot view (e.g., be sent) posts older than 24 hours.

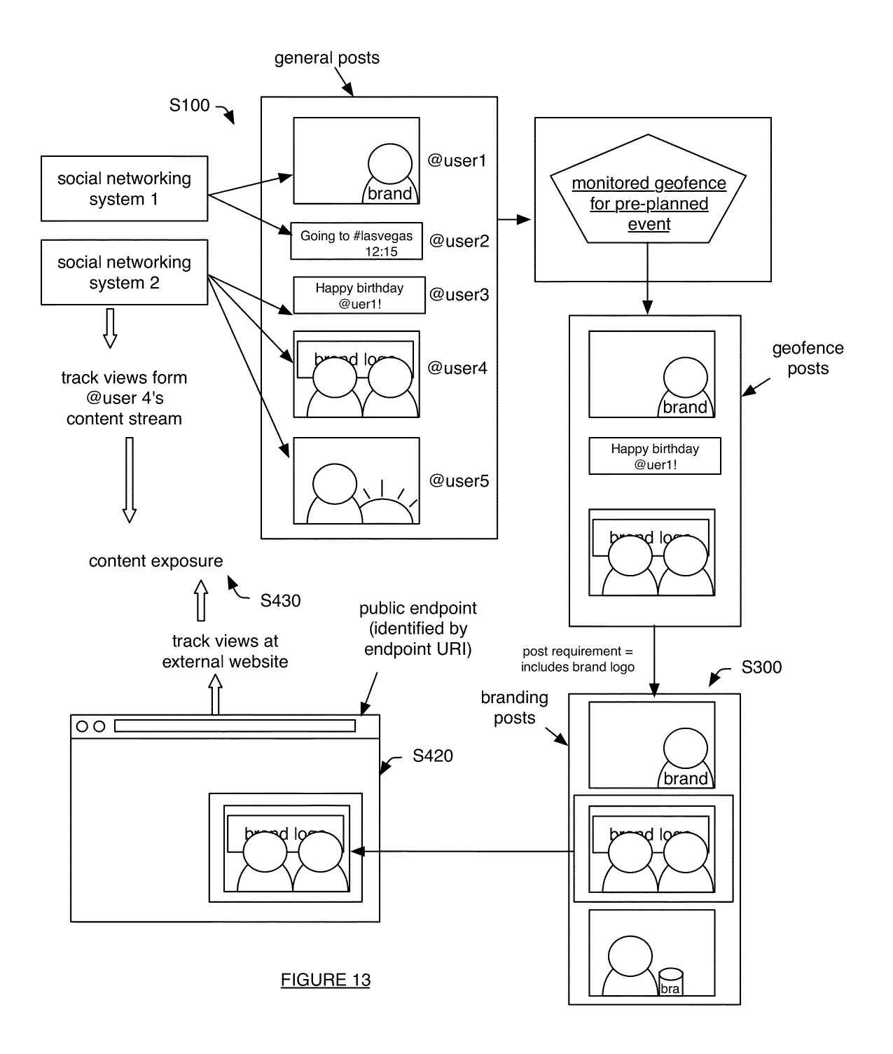

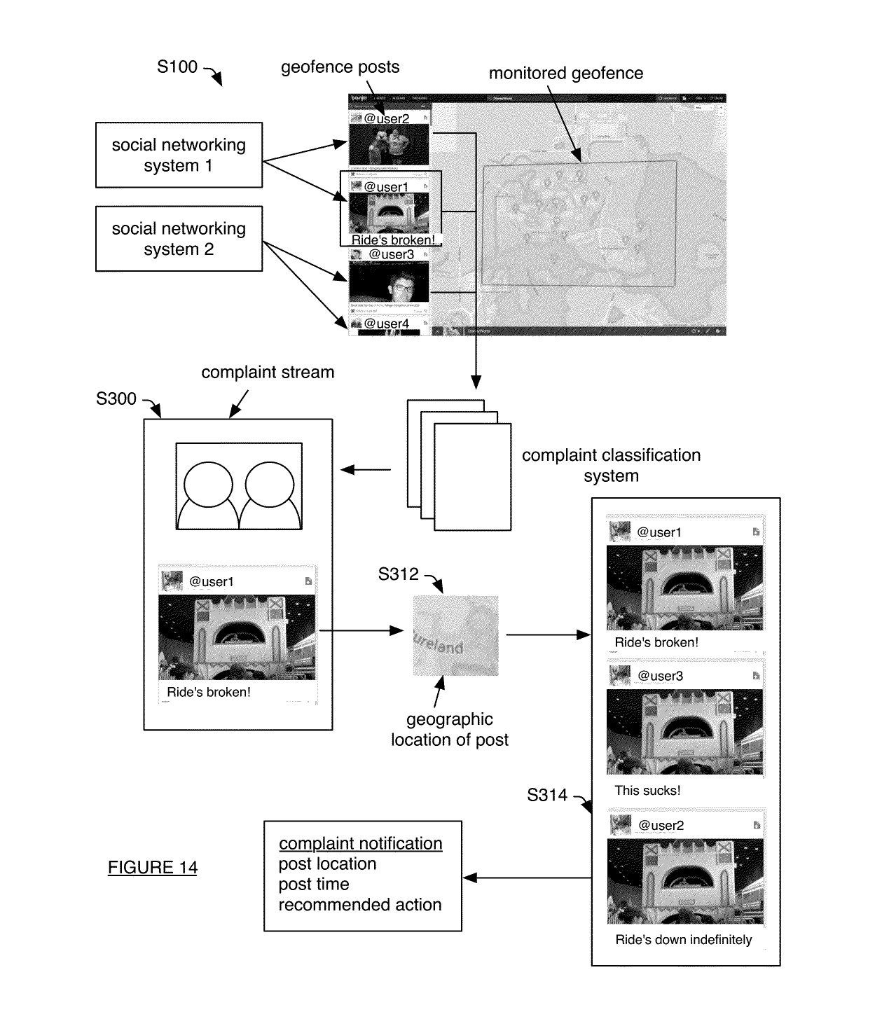

In a third specific example, a brand entity can monitor a monitored geofence (predetermined geofence) during a monitoring timeframe (predetermined timeframe) for posts of interest (example interface shown in FIG. 11, example method shown in FIG. 13). The posts of interest can be geofence posts containing images with a logo associated with the brand entity (predetermined logo), or be posts satisfying any other suitable set of post requirements. For example, Budwiser™ can monitor a baseball game for posts with images containing Budwiser™ cans, banners, shirts, or other paraphernalia. The identified posts are brand posts that include an image with at least a portion of the predetermined logo, and the brand posts can be aggregated into the content stream and provided to the brand entity. The brand posts can additionally or alternatively include the brand name or any other associated keyword in the post's: text content, audio content, or any other suitable content. The brand post can additionally or alternatively be associated with the brand entity through any other suitable set of factors. The brand entity can then select a post from the content stream for use in a subsequent advertising campaign at an endpoint identified by an endpoint URI (e.g., a website, a social networking system of the plurality, a different social networking system, etc.), or use the post content in any other suitable manner.

4. User Account Interaction with Content Stream Posts

Facilitating user account interaction with posts of the content stream S400, functions to enable the user account to interact with the post itself, the post identifier, the post content, and/or the post authors. The interactions are preferably performed on posts selected by the user account from the content stream, but can alternatively be performed on any other suitable set of posts identified in any other suitable manner. Examples of interactions that can be enabled include: adding selected posts to a second content stream (e.g., a publication stream for subsequent publication; a monitoring stream to monitor subsequent posts from the author or location; a customer support stream; etc.), removing selected posts from the content stream, or include any other suitable set of interactions.

In a first variation, facilitating user account interaction with posts of the content stream S400 includes requesting use permissions from the author S410. This can function to grant copyright permissions for the post content (e.g., images, etc.) to the user account. The use permissions can be automatically requested by the system, be requested by the user account, or be otherwise requested. Requesting the use permissions can include: receiving a use request associated with a selected post identifier of the content stream from the user account; in response to receipt of the use request, identifying the author that generated the post identified by the selected post identifier; in response to receipt of the use request, identifying the social networking system from which the post was received; sending a permissions request to the author through the identified social networking system, and notifying the user account when the author grants the use request. The method can additionally include removing the post from the content stream in response to the author denying the permissions request. The permissions request can include a reference to the post content, an accept option and a deny option, and/or include any other suitable information. The permissions request can be automatically generated, received from the user account, or otherwise determined. The permissions request can be sent as a private message, post on the author's content stream within the social networking system, or be otherwise communicated to the author. Alternatively, the permissions request can be sent to a different social networking system that the author has an account on. However, the permissions request can be otherwise communicated to the author.

In a second variation, facilitating user account interaction with posts of the content stream S400 includes publishing the posts on a public endpoint S420, which functions to use the post content for a secondary purpose, such as in a news story or as part of a branding or advertising campaign. Publishing the posts can include: receiving a publication request for a post (e.g., a post identifier) from the user account and sending the post to an endpoint. The publication request can include a post identifier (e.g., individually or as part of a publication stream or other secondary content stream), an endpoint URI, a security token, a publication time, and/or any other suitable information. The method can additionally include branding the post with a logo associated with the originating social networking system. The post or content stream is preferably sent to the endpoint (e.g., to the endpoint URI) in response to receipt of the publication request, and can be sent at a publication time or in response to the occurrence of any suitable publication event. The endpoint can be a social networking system, a system widget (e.g., embedded in the endpoint), website, browser plugin, application, or be any other suitable endpoint. The posts can be published to the endpoint in real- or near-real time with new geofence, event, or other posts as they are received, but the published posts and/or other information can alternatively be updated manually or be updated at any other suitable frequency. Publishing the posts can additionally include: checking the privacy settings for each post before publication, obtaining use permissions for each post before publication (e.g., as disclosed above in the first variation), classifying the endpoint (e.g., based on the endpoint URI, by querying the endpoint, etc.), and adjusting content stream parameters based on the classification, or performing any other suitable action on the posts. Privacy settings for each post requested for publication can be sent prior to sending the identifiers, wherein only posts with public settings are sent, but the privacy settings for each post can remain unverified. The endpoints can be classified using machine learning modules (e.g., trained or untrained), deep learning modules, neural networks, probabilistic clustering, object matching algorithms, or using any other suitable analysis method. Content stream update frequencies, post requirements, or any other suitable parameter can be adjusted based on the endpoint classification. In one example, the endpoint URI can be classified as a live broadcast request, wherein the system can automatically provide publication stream to the endpoint URI and concurrently cease content stream or publication stream updating in response to receipt of the publication request receipt, such that only user-curated and/or approved posts appear in the live broadcast, at the detriment of leaving out the most up-to-date content. The event content stream, event parameter values, and/or other event signals can be concurrently analyzed using subsequently received posts in the background during the live broadcast. However, any other suitable parameter can be automatically adjusted. The method can additionally include verifying the token for the endpoint URI (e.g., wherein the token is a private token provided to the user account) and/or verifying that the user account has permissions to use the content.

In a third variation, facilitating user account interaction with posts of the content stream S400 can enable the user account to identify and contact witnesses. In this variation, the content stream can include witness posts, wherein the content stream can additionally include an option to contact the author of the witness post (e.g., the witness). In response to receipt of a witness contact request, the system can automatically send a standard or custom message (e.g., received with the witness contact request) to the witness and/or facilitating communication between the witness and the user account. However, the method can facilitate any other suitable user account interaction with the posts.

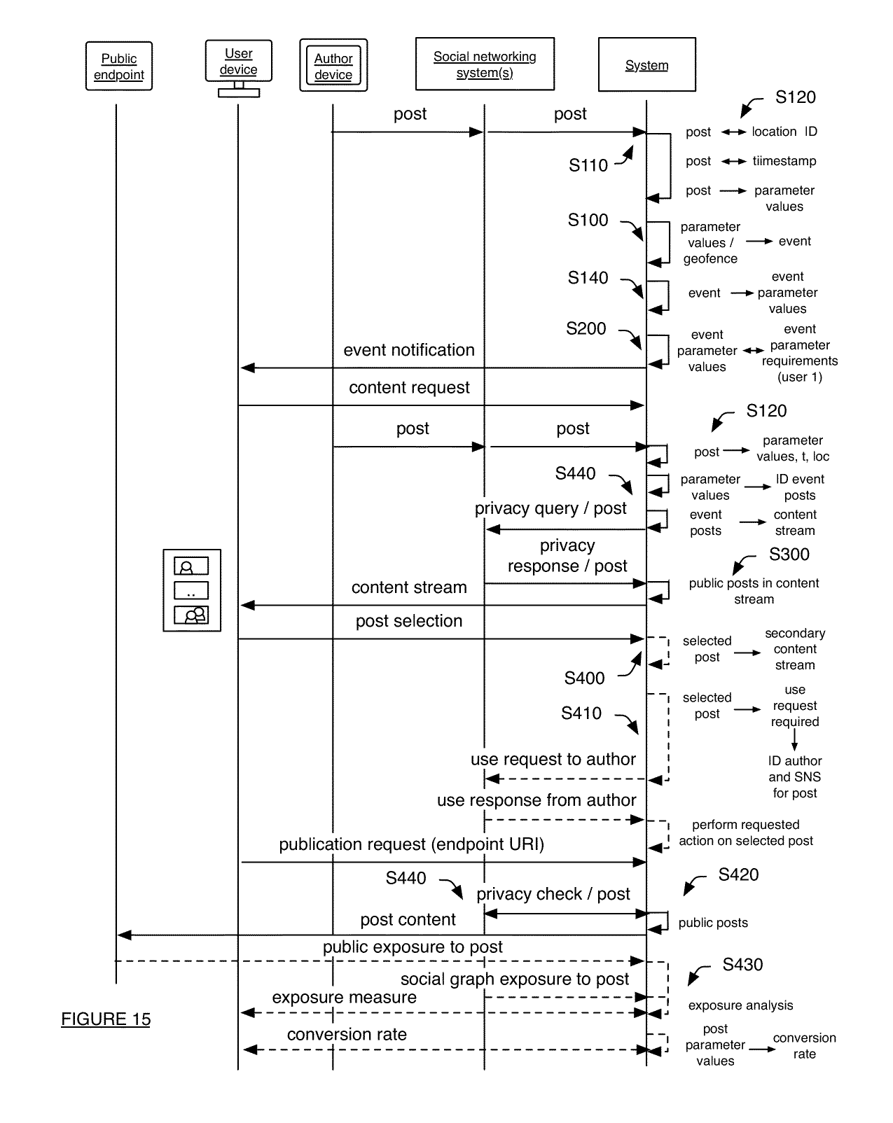

In a fourth variation, facilitating user account interaction with posts of the content stream S400 can include analyzing public exposure to the post S430, which can function to provide advertising campaign feedback (example shown in FIG. 15). The measure of public exposure can be used to determine the conversion rate of an advertisement (e.g., in this instance, the conversion rate of the post content), the return on investment of the advertisement, the billing amount for an advertisement, or be used in any other suitable manner. Analyzing public exposure to the post can include: determining a measure of exposure for the post (e.g., brand post) identified by the selected post identifier; and sending the measure of exposure to the user account (e.g., the branding entity associated with the brand post). The measure of exposure can be a total number of views, an estimated number of views, a total number of conversions or conversion rate, a return on investment (e.g., based on the number of conversions), or include any other suitable measure of exposure. The exposure and/or conversion can be determined using machine learning modules (e.g., trained or untrained), deep learning modules, neural networks, probabilistic clustering, object matching algorithms, or using any other suitable analysis method.

In one example, a conversion can be determined based on tracking the potential customers that were exposed to the content (e.g., through their respective social networking system accounts, through the endpoint, or through another channel), and determining whether the potential customer: subsequently purchased the product, subsequently posted content about the product or brand, subsequently posted an image with themselves and the product, or otherwise interacted with the brand. In a specific example, a conversion can be determined when the potential customer subsequently posts content (e.g., through one of any associated social networking system account, wherein the actions can include: reposting, commenting, replying, or any other suitable measure of post engagement) having factor values associated with the brand (e.g., images including a portion of the logo, images including objects, such as cans, including a portion of the logo, text including the brand name, etc.).

The measure of exposure can be determined based on: the exposure to the post content at the endpoint (e.g., associated with the endpoint URI), the exposure to the post content based on a social graph of the respective author within the respective social networking system (e.g., wherein the social graph can include, on the social networking system: the immediate contacts of the author, the author's friends, friends of the author's friends, the author's community, public members, or any other suitable social networking system account that can access the author's post), based on the exposure to the post content based on the social graph of a different account of the author on other social networking systems (e.g., linked to the originating social networking system), and/or through any other suitable source. The exposure can be tracked as an estimated number of views, actual number of views (e.g., tracked using a counter), or tracked in any other suitable manner. The total exposure is preferably the aggregate (e.g., sum) of all exposure sources, but can alternatively be a subset or multiple of the exposure through the exposure sources.

In one variation, determining the total number of views of a post can include: tracking a first number of views at the endpoint identified by the endpoint URI; determining a second number of views from the originating social networking system from which the event post was received and/or any secondary social networking system linked to the originating social networking system; and determining the number of views based on the first and second number of views.

In a specific example, a branding entity (e.g., beverage company) can have banners at a sporting event and give away promotional materials (e.g., branded beverages, branded apparel, branded fliers, etc.). The method can monitor the sporting event geographic area during the sporting event time period for posts, generated by the attendees, with images including all or a part of the brand's logo, wherein the brand's logo can appear in images of attendees in front of the banners, in images of the attendees interacting with the promotional materials, or any post content including the brand logo (branding posts). The branding entity can be provided with a content stream composed of these branding posts, and can select branding posts from the stream to push to real-time advertising endpoints. For example, the brand can select a branding post to push to the brand's website (e.g., through a widget provided by the system), to advertisements on billboards within the sporting event location, to advertisements on social networking systems (e.g., through a system widget, through a channel provided by the social networking system, for example as a featured or promoted post), or to any other suitable endpoint. The entire post or a portion thereof (e.g., only the image) can be pushed to the endpoint. The public exposure to the selected branding post can include: tracking the number of views of the post and/or the viewer identities at the website through the widget; estimating the number of views of the post through the billboard based on the number of attendees at the event; receiving the number of views of the post at the social networking system(s) from the respective social networking system(s); and estimating the number of views of the post and/or receiving the number of views of the post based on the social graph((s) of the author. The public exposure to the selected branding post can additionally include: identifying the post on a third party website (e.g., wherein the post has been shared without system notification); and determining the public exposure (e.g., number of views) to the post on the third party website. The presence of the post on the third party website can be automatically determined (e.g., by monitoring one or more potential endpoints), manually determined, or otherwise determined. The public exposure to the post can be determined by requesting the number of views of the post or surrounding content from the third party website, requesting the number of visits to the page from an advertising entity associated with the third party website, counting the number of views of the post through a system widget on the third party website (e.g., through an I-frame), or otherwise determining the public exposure to the post on the third party website.

The exposure information can be used to determine the conversion rate for the branding entity. The conversion rate can be determined as disclosed above. In one specific example, the conversion rate can be determined from the number of potential customers that post content (e.g., based on the general posts, event posts, or other posts subsequently received) that include the brand logo after the branding post was pushed to the advertising endpoints and/or after the potential customer was exposed to the branding post (e.g., tracked through the widget or social networking systems). The method can additionally include tracking the conversion rate and/or return on investment for the first branding post, and recommending a second branding post or providing the content stream of branding posts when the conversion rate and/or ROI is below a threshold rate or ROI, such that the advertising material can be updated in near-real time.

The exposure information can additionally be used to determine the billing rate and/or amount that the sporting entity (e.g., event entity) should charge the branding entity. This can be particularly relevant when the event entity charges based on the public exposure. For example, the event entity can not only charge based on the number of attendees at the event, but can also charge based on the number of social networking system users that were exposed to event posts or branding posts that were posted by event attendees. However, any other suitable module can be provided to the user accounts to leverage dynamic, real-time event detection and/or event-related post identification.

In a fifth variation, facilitating user account interaction with posts of the content stream S400 can include checking the privacy status of each post S440, which functions to ensure that posts having private statuses are not presented to the public. The privacy setting for each post is preferably checked before presentation to the user account, sending to the endpoint URI (e.g., for public presentation), or before presentation to any user without viewing permissions. Public posts are preferably the only posts that are surfaced to the user account and/or useable by the user account, but any other suitable post can alternatively be used. Private posts can be used to augment and adjust the event signal (e.g., the event parameter values), used to determine which public posts will be more relevant to the event, and/or used in any other suitable manner, but are preferably not presented to the user account (e.g., as part of the content stream). However, private posts can be presented to the user account or be otherwise used. The post privacy setting can be checked in the manner disclosed in U.S. Provisional Application No. 62/093,749 filed 18 Dec. 2014, incorporated herein in its entirety by this reference, but can alternatively be checked in any other suitable manner.

The privacy status of a post can be public, private, or limited (e.g., to a predetermined set of social networking system connections). The post privacy status can be assigned to the individual post, assigned to all posts generated by the author, inherited from the authoring account privacy status (e.g., wherein the post is private when the authoring account is private), or otherwise determined. The post can be treated as private by default unless the privacy status is public (e.g., globally available), public by default unless the privacy status is private or limited, or be otherwise treated. The post privacy status can be checked each time the post is to be presented to a user account or endpoint, which can function to accommodate for post privacy status changes. However, the post privacy status can be checked at any other suitable frequency.

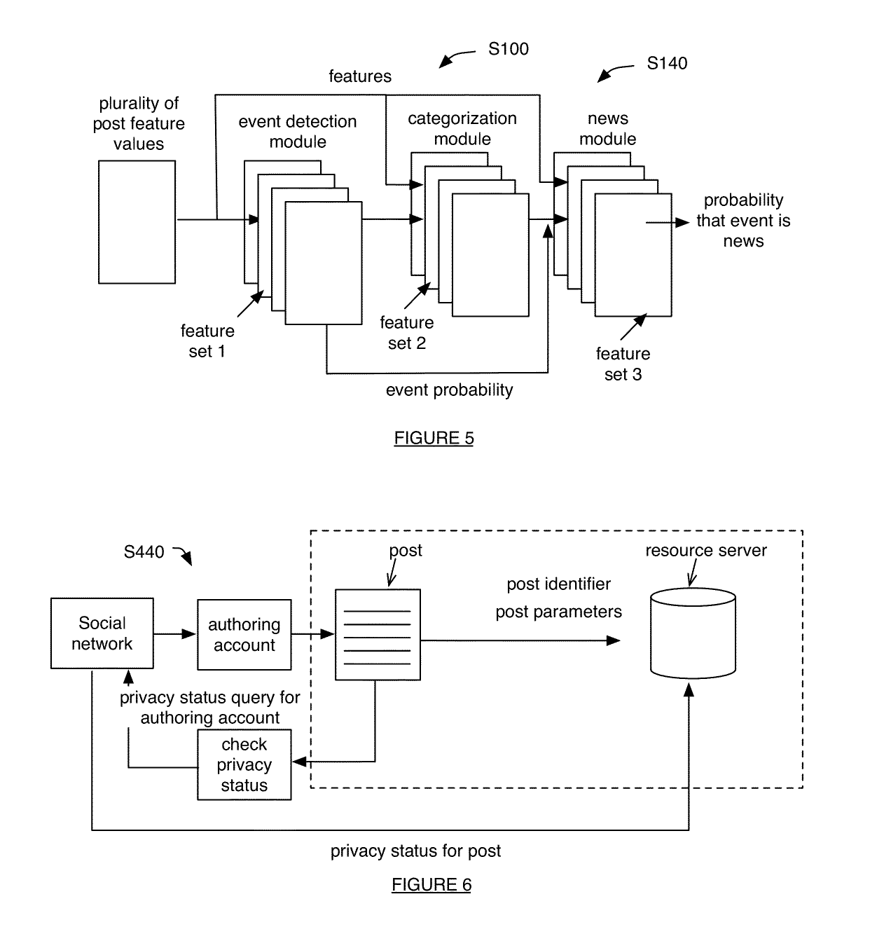

In one variation, the privacy setting of a post is checked in response to receipt of the request of an action on the post. Action requests can include: requests to view a content stream, requests to use the post (e.g., individually or as part of a content stream, such as by publishing the post or content stream at an endpoint, publishing the post or content stream as part of a live broadcast, publishing the post or content stream on a social networking system, publishing the post or content stream on an entity website or through a widget, etc.), or include any other suitable request to perform any other suitable action on the post. Checking the privacy setting for a post can include: determining the social networking system from which the post was received; and querying the social networking system from which the event post was received for a privacy status associated with the event post (example shown in FIG. 6). The post can be removed from the content stream or shown as unavailable when the post has a private status, or can be otherwise treated in response to determination that the post has a private status. The requested action can be performed on the post when the post has a public status, but any other suitable action can be performed in response to determination that the post has a public status.

The method can additionally include validating the event S500, which functions to verify that the event is actually occurring at the location. The event is preferably validated before the event notification is sent to the user account, but can alternatively be validated afterward or at any suitable time. Validating the event S500 can include: determining an anomaly probability for the post from which the event was initially detected and/or the event posts; and validating the event in response to the anomaly probability exceeding a threshold anomaly probability. The anomaly probability for the post can be determined based on historic posts from the authors of the event posts; historic posts associated with the geofence; secondary information received from secondary sources; and/or any other suitable information. For example, the post can have a high anomaly or verification probability if smoke is present in the post's image, smoke is not present in the nearest neighbor posts for the geographic location (e.g., typically not seen in the geographic location during that time of day), smoke is not present in past posts by the author, smoke is not present in the past posts by social connections to the author (e.g., through the author's social graph), and the post depicts blue sky in the background (indicative of daylight) and the current weather for the geographic location indicates that it is currently daytime with clear skies. The post or event can have a lower verification probability if the author recently posted pictures of smoke from another geographic location. In a second variation, the event can be validated by querying the author of an event post (e.g., sending a message to the author through the originating social networking system to query whether the event is occurring). However, the event and/or post can be otherwise validated. The event can be verified using machine learning modules (e.g., trained or untrained), deep learning modules, neural networks, probabilistic clustering, object matching algorithms, or using any other suitable analysis method.

An alternative embodiment preferably implements the above methods in a computer-readable medium storing computer-readable instructions. The instructions are preferably executed by computer-executable components preferably integrated with an event curation system. The event curation system can include a resource system configured to index social networking system posts in near-real time, event detection system configured to detect the event from the posts in near-real time, event validation system configured to validate the event occurrence, and post publication system configured to publish all or a portion of the post content to an endpoint supplied by the user account. The computer-readable medium can be stored on any suitable computer readable media such as RAMs, ROMs, flash memory, EEPROMs, optical devices (CD or DVD), hard drives, floppy drives, or any suitable device. The computer-executable component is preferably a processor but the instructions may alternatively or additionally be executed by any suitable dedicated hardware device.

Although omitted for conciseness, the preferred embodiments include every combination and permutation of the various system components and the various method processes, wherein the method processes can be performed in any suitable order, sequentially or concurrently.

As a person skilled in the art will recognize from the previous detailed description and from the figures and claims, modifications and changes can be made to the preferred embodiments of the invention without departing from the scope of this invention defined in the following claims.

We claim:

1. A method for event detection and content surfacing, comprising:
receiving a plurality of posts from a plurality of social networking systems, wherein each post is generated by a different author on the respective social networking system, wherein each post is identified by a unique post identifier;
for each post of the plurality, determining a geographic identifier, a timestamp, and a set of post parameter values for the post;
for a geofence, detecting an event at a first time based on the post parameter values of geofence posts, wherein geofence posts are posts of the plurality that are associated with geographic identifiers within the geofence and associated with timestamps within a predetermined time duration of the first time;
generating event parameter values based on the post parameter values of the geofence posts;
sending an event notification for the event to a user account in response to the event parameter values satisfying a set of event parameter requirements associated with the user account;
automatically aggregating post identifiers for event posts into a content stream, wherein the event posts are geofence posts that are associated with the first geographic identifier and with the detected event, as determined based on the respective post parameter values;
receiving a request for content associated with the event from the user account;
in response to receipt of the request, checking privacy settings for each event post within the content stream, comprising:
querying the social networking system from which the event post was received for a privacy status associated with the event post;
removing the post identifier for the event post from the content stream when the event post is private; and
sending the content stream to the user account after checking privacy settings for each event post.

2. The method of claim 1, wherein the content stream consists essentially of post identifiers for event posts including image frames.

3. The method of claim 1, further comprising validating the event prior to sending the event notification, wherein validating the event comprises:
determining an anomaly probability for the post, based on historic posts from the authors of the event posts and historic posts associated with the geofence; and
validating the event in response to the anomaly probability exceeding a threshold anomaly probability.

4. The method of claim 1, further comprising:
automatically updating the content stream with post identifiers of subsequently received event posts, identified from subsequently received posts, such that the content stream is updated in near-real time; and
automatically updating the event parameter values in near-real time based on the subsequently received posts, wherein the subsequently received posts comprise subsequently received global posts and geofence posts, wherein the global posts comprise posts associated with geographic identifiers outside of the geofence.

5. The method of claim 4, wherein the user account represents a news entity, the method further comprising:
receiving post identifier selections from the content stream from the news entity;
aggregating the post identifier selections into a publication stream; and
in response to receipt of a live broadcast request from the news entity, concurrently:
providing the publication stream to the news entity; and
updating the content stream and event parameter values based on the subsequently posts received from the set of social networking systems.

6. The method of claim 5, further comprising:
receiving an endpoint URI from the first user account;
classifying the endpoint URI as the live broadcast request; and
ceasing content stream updating in response to publication request receipt;
wherein sending the content stream to the user account comprises sending the content stream to the endpoint URI.

7. The method of claim 5, further comprising a second user account representing a branding entity associated with a predetermined geofence and a predetermined logo, wherein the set of event parameter requirements associated with the first user account comprises a news event probability above a threshold probability value, wherein a post identifier is included within the content stream in response to the identified post being classified as an event post for an event having a news event probability above the threshold probability value, and is included within a second content stream associated with the second user account in response to the identified post including an image including a portion of the predetermined logo and being associated with a geographic identifier within the predetermined geofence.

8. The method of claim 7, further comprising:
receiving a post identifier selection from the second content stream and an endpoint URI from the second user account;
sending the selected post identifier to the endpoint URI at a publication time in response to receipt of the selection; and
determining a measure of exposure for the brand post identified by the selected post identifier through the endpoint URI and based on a social graph of the respective author within the respective social networking system.

9. The method of claim 1, further comprising:
receiving a use request associated with a selected post identifier of the content stream from the user account;
in response to receipt of the use request, identifying the author that generated the post identified by the selected post identifier and identifying the social networking system from which the identified post was received;
sending a permissions request to the author through the social networking system, the permissions request comprising an accept option and a deny option; and
removing the selected post identifier from the content stream in response to receipt of the deny option from the author.

10. A method for breaking news discovery, comprising:
a) detecting a news event within a geofence at a first time from a plurality of posts received from a plurality of social networking systems, wherein the posts were posted to the respective social networking system within a predetermined time duration from the first time;
b) identifying event posts associated with the event from the set of posts;
c) aggregating post identifiers for the event posts into a content stream;
d) determining event parameter values based on post parameter values extracted from the event posts;
e) receiving event parameter requirements from a news entity;
f) in response to the event parameter values satisfying the event parameter requirements, sending the content stream to the news entity;
g) receiving, from the news entity, selections of post identifiers from the content stream;
h) for each of the selected post identifiers, checking privacy settings for the post and adding the post identifier to a publication stream when the post is public; and
i) in response to receipt of a live broadcast request from the news entity, concurrently:
providing the publication stream to the news entity; and
repeating b) to d) for new posts received from the set of social networking systems.

11. The method of claim 10, further comprising:
receiving the plurality of posts, each generated by a different author, from the plurality of social networking systems;
associating a geographic identifier and timestamp with each post; and
extracting post parameter values from each post;
wherein the plurality of posts comprise geofence posts, wherein the geofence posts are posts of the plurality that are associated with timestamps within a threshold time period of the first time and associated with the geofence through the respective geographic identifiers, wherein the news event is detected based on post parameter values of the geofence posts, and wherein the geofence posts comprise the event posts.

12. The method of claim 11, wherein detecting the news event further comprises:
determining an event probability for the geofence based on a first subset of the geofence post parameter values;
categorizing the event with an event category based on a second subset of the geofence post parameter values, different from the first subset; and
determining a news probability for the geofence based on the event categorization, the event probability, and a third subset of geofence post parameter values, different from the third subset, wherein a news event is detected in response to the news probability exceeding a threshold news probability.

13. The method of claim 12, wherein the event parameter requirements comprise a monitored category, wherein the event parameter values satisfy the event parameter requirements when the event category falls within the monitored category.

14. The method of claim 11, further comprising:
determining an event identifier from the post parameter values for the event posts;
associating the event identifier with the event posts;
receiving a timeframe request from the news entity for the event identifier, the timeframe request comprising a start and end time;
identifying event posts that are associated with the event identifier and a timestamp falling between the start and end time;
checking privacy settings for each identified event post; and
sending identifiers for the event posts that are public to the news entity.

15. A method for content surfacing, comprising:
receiving a plurality of posts from a plurality of social networking systems, wherein each post is generated by a different author on the respective social networking system, each post identified by a unique post identifier;
for each post of the plurality, determining a geographic identifier, timestamp, and set of post parameter values based on the respective post;
for a predetermined geofence and predetermined timeframe, identifying event posts, wherein the event posts are posts of the plurality that are associated with geographic identifiers located within the predetermined geofence and timestamps within the predetermined timeframe;
receiving a predetermined logo from a branding entity;
identifying brand posts from the event posts, each brand post comprising an image with a portion of the predetermined logo;
aggregating post identifiers for the brand posts into a content stream;
for each brand post within the content stream, checking a privacy status for the brand post;
sending the content stream to the branding entity;
receiving, from the branding entity, a selection of a post identifier of the content stream and an endpoint URI; and
sending the selected post identifier to the endpoint URI at a publication time in response to receipt of the selection.

16. The method of claim 15, further comprising:
determining a measure of exposure for the brand post identified by the selected post identifier; and
sending the measure of exposure to the branding entity.

17. The method of claim 16, wherein determining the measure of exposure for the brand post identified by the selected post identifier comprises determining a total number of views of the image of the brand post, comprising:
tracking a first number of views at the endpoint identified by the endpoint URI;
determining a second number of views from the social networking system from which the event post was received; and
determining the number of views based on the first and second number of views.

18. The method of claim 17, herein determining the second number of views from the social networking system from which the brand post was received comprises estimating the second number of views based on a social graph of the respective author within the social networking system.

19. The method of claim 16, further comprising:
detecting a complaint from a first event post, the first event post associated with a first geographic identifier and a first timestamp;
validating the complaint; and
sending a complaint notification comprising the complaint and a complaint location to the branding entity, wherein the complaint location is determined based on the first geographic identifier.

20. The method of claim 19, wherein validating the complaint comprises:
identifying secondary event posts that are associated with geographic identifiers located proximal the first geographic identifier and associated with timestamps within a predetermined time period of the first timestamp;
identifying a subset of post parameters indicative of the complaint, based on the post parameter values of the first event post;
determining a complaint similarity probability based on values of the subset of post parameters for the secondary event posts; and
classifying the complaint as a valid complaint in response to the complaint similarity probability exceeding a threshold probability.
